(19) United States
(12) Patent Application Publication
(10) Pub. No.: US 2021/0097911 A1
(43) Pub. Date: Apr. 1, 2021

(54) CAPACITIVE MEASUREMENT FOR VCOM DRIFT COMPENSATION

(71) Applicant: Apple Inc., Cupertino, CA (US)

(72) Inventors: Scott R. Johnston, San Francisco, CA (US); Shih-Chyuan Fan Jiang, San Jose, CA (US); Chaohao Wang, Sunnyvale, CA (US)

(21) Appl. No.: 17/033,740

(22) Filed: Sep. 26, 2020

Related U.S. Application Data
(60) Provisional application No. 62/906,588, filed on Sep. 26, 2019.

(51) Int. Cl. G09G 3/00; G09G 3/36; G02F 1/1362

(52) U.S. Cl. CPC G09G 3/006; G09G 3/3655; G02F 1/1362; G02F 2001/136254; G09G 2320/0247; G09G 2300/0413; G09G 2320/0204

(57) ABSTRACT

Liquid crystal display panels and methods of addressing Vcom drift using capacitive measurements as a substitute for direct optical flicker measurements.

### CROSS-REFERENCES TO RELATED APPLICATIONS

This application claims the benefit of U.S. Provisional Application No. 62/906,588, filed Sep. 26, 2019 entitled “Capacitive Measurement For Vcom Drift Compensation,” the disclosure which is incorporated by reference herein in its entirety.

### FIELD

Aspects of the disclosure relate in general to displays. Aspects include a method and liquid crystal display (LCD) device configured to compensate for common voltage (Vcom) drift.

### BACKGROUND

### Description of the Related Art

A liquid-crystal display (LCD) is a flat-panel display or other electronically modulated optical device that uses the light-modulating properties of liquid crystals. Liquid crystals do not emit light directly, instead using a backlight or reflector to produce images in color or monochrome. LCDs are used in many portable devices such as laptops and mobile phones.

A pixel element within a liquid crystal display is commonly driven by applying a voltage across a signal electrode and a common electrode to control the orientation of liquid crystals within a liquid crystal layer. In a vertical alignment mode, the signal electrode and common electrode are arranged on opposite sides of the liquid crystal layer. Other configurations such as in-plane switching and fringe-field switching have been proposed in order to improve viewing angle. In an in-plane switching mode, the signal electrodes and common electrodes are arranged side-by side to each other on a bottom substrate as interdigital electrodes, with the liquid crystal layer formed above the interdigital electrodes. In a fringe-field switching mode, the signal electrodes are formed above a common electrode layer, with the liquid crystal layer formed above the signal electrodes.

Alignment of the liquid crystals can be accomplished by applying either a positive or negative voltage across the electrodes. LCD screens commonly set the common electrodes at a common voltage (Vcom) at a midpoint of the video signal applied to the signal electrodes. For example, if a video signal swings between 0 Volts (V) and 10 V, the Vcom may be set at 5 V. However, it has been observed that variations in panel construction may result in an optimal Vcom different from panel to panel, or across a single panel. In an exemplary circumstance where the resultant Vcom is actually 5.5 V, the positive full-scale voltage may be 4.5 V while the negative full-scale voltage swing may be 5.5 V. Thus, LCD display panels may commonly exhibit flicker where the full-scale voltage differs between adjacent frames.

### SUMMARY

Embodiments include a liquid crystal display configured to compensate for common voltage drift through measuring capacitance.

In one embodiment, an apparatus comprises a liquid crystal display panel, a capacitance measuring circuit, and a digital to analog converter. The liquid crystal display panel comprising a plurality of active pixels and a plurality of dummy pixels. The active pixels are configured to display an image visible to a user. The dummy pixels being not visible to the user. The capacitance measuring circuit is configured to measure a capacitance of at least one dummy pixel. The digital to analog converter is configured to receive the capacitance of the at least one dummy pixel, and to adjust common voltage (Vcom) received by the active pixels based on the received capacitance of the at least one dummy pixel. The apparatus may be a tablet computer, mobile phone, augmented reality display, notebook computer, computer display, or digital watch.

In a method embodiment, a capacitance measuring circuit measures a capacitance of at least one dummy pixel of a liquid crystal display panel. The liquid crystal display panel comprises a plurality of active pixels and a plurality of dummy pixels. The active pixels configured to display an image visible to a user. The dummy pixels are not visible to the user. The digital to analog converter receives the capacitance of the at least one dummy pixel, and adjusts Vcom received by the active pixels based on the received capacitance of the at least one dummy pixel. The liquid crystal display panel may be incorporated in a tablet computer, mobile phone, augmented reality display, notebook computer, computer display, or digital watch.

In another aspect of the disclosure, an apparatus comprises a liquid crystal display panel, a capacitance measuring circuit, and a digital to analog converter. The liquid crystal display panel comprises a plurality of active pixels. The active pixels are configured to display an image visible to a user. The capacitance measuring circuit is configured to measure a capacitance of at least one active pixel when the liquid crystal display panel is not in operation. The digital to analog converter is configured to receive the capacitance of the at least one active pixel. The digital to analog converter is further configured to adjust Vcom received by the active pixels based on the received capacitance of the at least one active pixel. The apparatus may be a tablet computer, mobile phone, augmented reality display, notebook computer, computer display, or digital watch.

In another method embodiment, a capacitance measuring circuit measures a capacitance of at least one active pixel of a liquid crystal display panel when the liquid crystal display panel is not in operation. The active pixels are configured to display an image visible to a user. The digital to analog converter receives the capacitance of the at least one active pixel, and adjusts Vcom received by the active pixels based on the received capacitance of the at least one active pixel. The liquid crystal display panel may be incorporated in a tablet computer, mobile phone, augmented reality display, notebook computer, computer display, or digital watch.

### BRIEF DESCRIPTION OF THE DRAWINGS

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

FIG. 1 is a schematic cross-sectional side view illustration of a pixel cell of a fringe-field switching (FFS) mode LCD panel with charge accumulation within an alignment layer creating an internal electric field.

FIG. 2 is test data illustrating Vcom drift over time for different LCD panels.

FIG. 3A is test data illustrating optical transmittance versus Vcom bias.

FIG. 3B is test data illustrating capacitance versus Vcom bias.

FIG. 4 illustrates an LCD panel with a column of dummy pixels in accordance with an embodiment.

FIG. 5 is a block diagram of an embodiment configured to correct for Vcom shift using a column of dummy pixels in an LCD panel.

FIG. 6 illustrates a circuit configured to measure capacitance as a substitute for measuring optical transmittance in accordance with an embodiment.

FIG. 7 is a block diagram of an embodiment configured to correct for Vcom shift using active pixels in an LCD panel.

FIG. 8A is diagram showing many capacitance measurements in order to determine an optimal Vcom value.

FIG. 8B is a diagram showing two capacitance measurements allowing for iterative adjustment to determine an optimal Vcom value.

FIG. 8C is a diagram showing two capacitance measurements, the degree of mismatch between the two capacitance measurements can be fed into a look-up table to determine the change in Vcom voltage.

### DETAILED DESCRIPTION

Embodiments describe liquid crystal display panel designs and methods of operation which may address Vcom drift and provide compensation to improve flicker, particularly at low refresh rates where flicker may be particularly observable by a user of the LCD panel.

In one aspect it has been observed that, in addition to flicker resulting from variations in panel construction affecting Vcom values and full-scale voltage swings, LCD panel flicker can additionally result from Vcom drift over operation time. For example, Vcom drift has been observed after hours of continuous use. It is believed that this Vcom drift may be attributed to charge accumulation that causes an imbalanced electric field on the liquid crystal over time.

Another aspect of the disclosure is the discovery that optical transmittance and capacitance of LCD panels vary similarly based on Vcom drift.

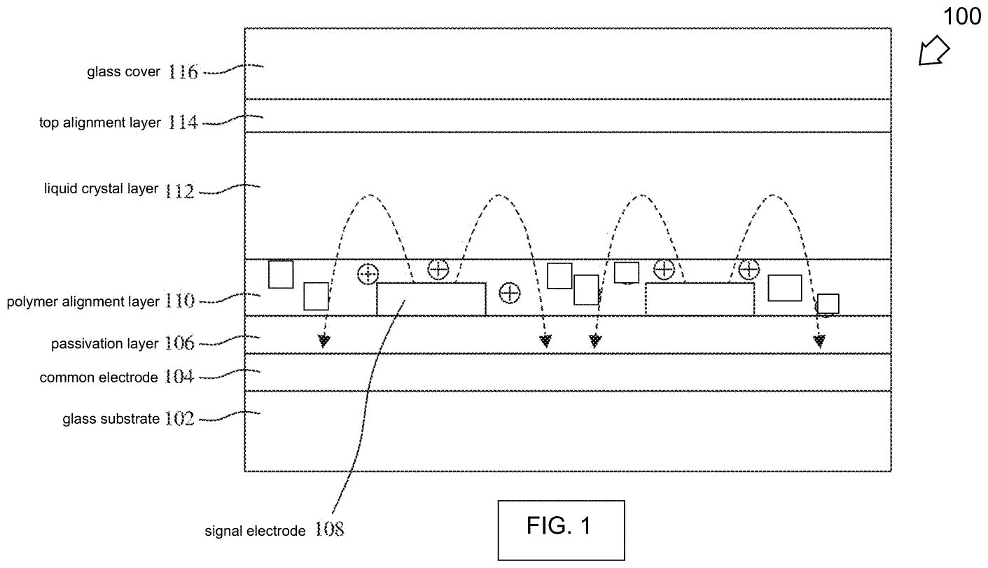

FIG. 1 is a schematic cross-sectional side view illustration of a pixel cell 100 of a fringe-field switching (FFS) mode LCD panel with charge accumulation within an alignment layer creating an internal electric field, in accordance with an embodiment of the present disclosure. As shown, an fringe-field switching mode LCD panel may include a glass substrate 102, a common electrode 104 on the glass substrate, a passivation layer 106 over the common electrode 104, and signal electrodes 108 on the passivation layer 106. The common electrode 104 and signal electrodes 108 may be formed of electrically conductive materials, including transparent conductive oxides (TCOs) such as indium-tin-oxide (ITO). Passivation layer 106 may be formed of transparent insulating materials such as silicon oxide (SiOx), silicon nitride (SiNx), silicon oxynitride (SiNx), etc. A polymer alignment layer 110 overlies the signal electrodes, and the liquid crystal layer 112 is formed on the polymer alignment layer 110. The polymer alignment layer 110 may be formed of transparent, organic materials such as polyimide (PI), nylon, or polyvinylalcohol (PVA). The top surface of the polymer alignment layer 110 may optionally include grooves to aide with alignment of the liquid crystals within the liquid crystal layer 112. A top alignment layer 114 may be formed over the liquid crystal layer 112, and a glass cover 116 placed over the top alignment layer 114.

Charge accumulation may due to an imbalanced work-function between the alignment layer 110 (e.g. polyimide) and signal electrodes 108 (e.g. ITO). It is believed that the work-function difference may allow for charges to be injected from the signal electrode 108 material and into the alignment layer 110 material, where the charges become trapped and create an internal electric field which in turn causes an imbalanced voltage in the liquid crystal layer.

In accordance with embodiments, it is believed that the accumulation of charges and the resulting internal electric fields contribute Vcom drift over time, and flicker caused by Vcom drift. In this aspect, embodiments describe LCD panel designs and methods of operation, which may address Vcom drift and improve flicker. It has been observed that a number of operational conditions affect Vcom drift, such as backlight intensity, gray level, and driving frequency over time.

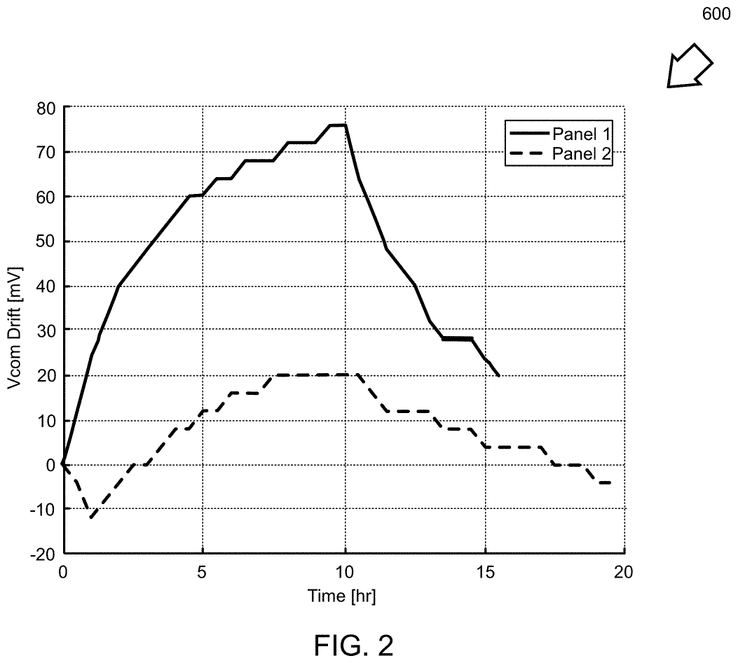

FIG. 2 illustrates test data 2000 depicting Vcom drift over time for different LCD panels 1000a-b, in accordance with an embodiment of the present disclosure. In this example, two different panels 1000a-b may have highly different Vcom drift profiles over time. Panel to panel variation may result in different Vcom drift profiles. The different Vcom drift profiles may also occur because of different LCD backlight intensities used by the LCD panels 1000a-b. As a result of the differing Vcom drift profiles between panels, feed-forward compensation of Vcom drift of a generic panel is impossible without further information.

Because LCD panel flicker can additionally result from Vcom drift over operation time, one solution is to measure or detect flicker of the display panel and adjust Vcom appropriately. An LCD panel embodiment may use extra-designated pixels on a camera/photo-detector to measure flicker of the LCD panel and adjust Vcom accordingly. Detection by an optical sensor may be a major engineering effort.

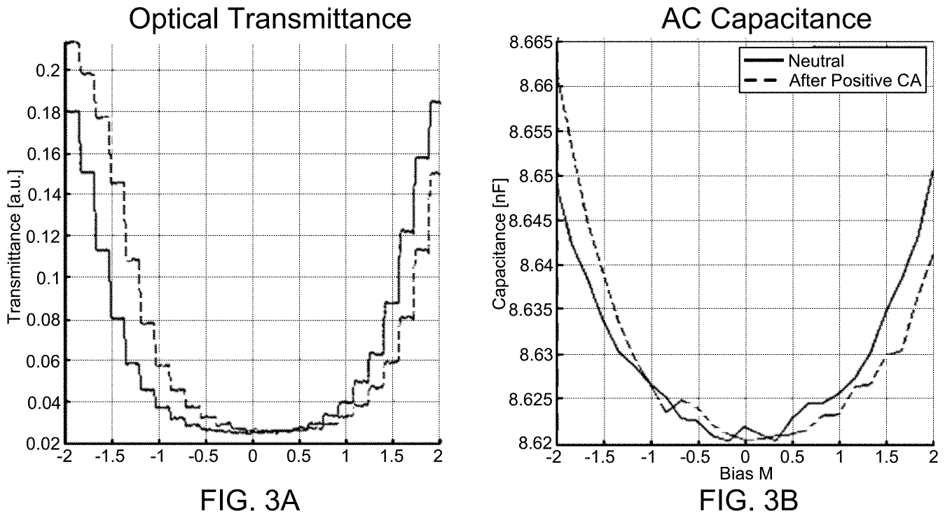

An electrical method of Vcom drift measurement is a simpler solution than using an optical sensor. The electrical method of Vcom drift measurement is enabled by the discovery that charge accumulation using optical transmittance and capacitance of LCD panels varies similarly based on Vcom drift, as shown in FIG. 3A and FIG. 3B in accordance with an embodiment of the present disclosure. The discovery was made by simultaneously measuring charge accumulation using transmittance and small-signal alternating current (AC) capacitance. FIG. 3A depicts test data illustrating measurements of optical transmittance versus Vcom bias, while FIG. 3B depicts test data illustrating capacitance measurements versus Vcom bias. The resulting curves show similar variation versus Vcom bias. While embodiments described herein use small signal capacitance, it is understood that the use of any capacitance measurements, whether small signal or large signal may be used. Furthermore, some embodiments described below address capacitance; it is understood by those familiar with the art that embodiments may address any form of capacitance including alternating current capacitance.

We now move to embodiments of a liquid crystal display panel and methods of operation, which may address Vcom drift and provide compensation to improve flicker.

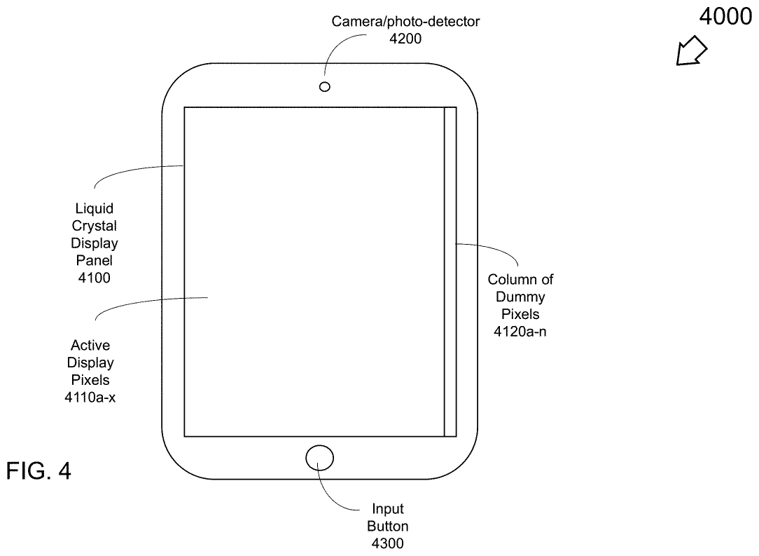

FIG. 4 exemplifies a tablet computer 4000 that has a liquid crystal display panel 4100 with a column of dummy pixels 4120 in accordance with an embodiment of the present disclosure. While this embodiment is described as a tablet computer 4000, it is understood by one skilled in the art, such alternate embodiments may also be a flat panel display, an integrated computer, tablet computer, augmented reality display, notebook computer, computer display, digital watch, mobile telephone, digital clock, television, or any other device known in the art that includes a liquid crystal display panel 4100.

As shown in FIG. 4, tablet computer 4000 embodiment has a liquid crystal display panel 4100, a camera/photo-detector 4200, and an input button 4300.

Liquid crystal display 4100 comprises a plurality of pixel cells 100. Pixel cells 100 can be active display pixels 4110 and dummy pixels 4120. Active display pixels 4110a-x are visible to users. Dummy pixels 4120 are not visible to users, and may be aligned into a column of dummy pixels 4120a-n. In an embodiment with dummy pixels 4120, the dummy pixels 4120 are used expressly to sense the capacitance of the pixels in the liquid display panel 4100—and not used for displaying an image. Alternatively, in embodiments where a column of dummy pixels 4120a-n are not present, a column of active display pixels 4110 may be used when the display is inactive.

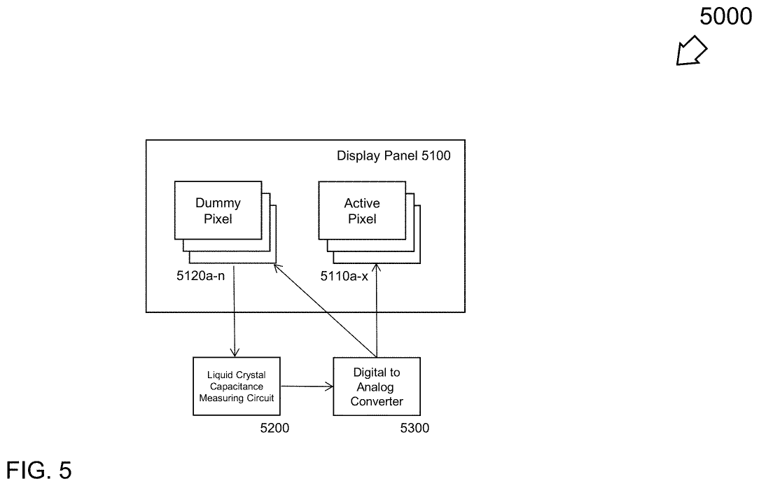

Moving on to FIG. 5, FIG. 5 is a block diagram of an embodiment configured to correct for Vcom shift using a column of dummy pixels in an LCD panel. The display 5000 essentially has three components, a display panel 5100, a liquid crystal capacitance measuring circuit 5200, and a digital to analog converter (DAC) 5300.

Display panel 5100 further comprises active pixels 5110a-x, and dummy pixels 5120a-n. As described earlier, active pixels 5110 are visible to users, and are used to display an image visible to a user. Dummy pixels 5120, which may be aligned into a column, may be visually masked from the user, and are used to sense the capacitance of the pixels in the liquid display panel 5100.

Digital to analog converter (DAC) 5300 is configured to convert digital video data into analog video signals, which connect to screen drivers to display monochrome or color images on display panel 5100. It is understood by those familiar with the art that the digital to analog converter 5300 may include a system (e.g. micro-controller) overseeing the acquisition of capacitance measurements, processing that data, then sending out the resulting adjustments in Vcom to the relevant digital to analog converter 5300. Digital to analog converter 5300 then outputs the adjusted Vcom.

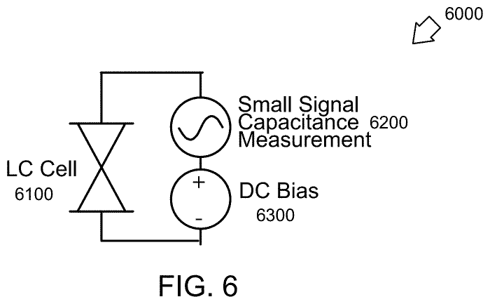

Liquid crystal capacitance measuring circuit 5200 is any circuit known in the art used to measure the capacitance of dummy pixels 5120 or active pixels 5110 when the display panel 5100 is inactive. One example liquid crystal capacitance measuring circuit 5200, configured to measure capacitance as a substitute for measuring optical transmittance, is the circuit 6000 shown in FIG. 6, in accordance with an embodiment of the disclosure. As shown in FIG. 6, a liquid crystal cell 6100 (which may be a dummy pixel cell 5120 or an active pixel cell 5110) is electrically coupled to a small signal capacitance measurement circuit 6200 in series with a direct current (DC) bias 6300 to measure the capacitance of the liquid crystal cell 6100.

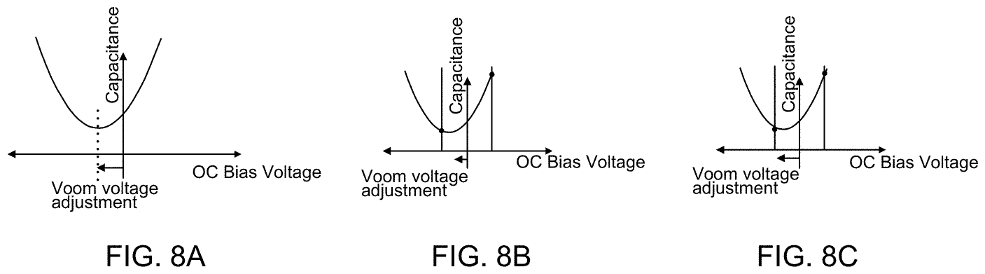

Returning to FIG. 5, while in operation, display panel 5100 displays images on active pixels 5110a-x. Liquid crystal capacitance measuring circuit 5200 measures the capacitance of dummy pixels 5120a-n as a substitute for measuring optical transmittance. The digital to analog converter 5300 receives the capacitance measurement from the liquid crystal capacitance measuring circuit 5200, and adjusts Vcom received by the active pixels 5110a-x for Vcom shift. There are several techniques on how Vcom value may be adjusted or determined. FIG. 8A illustrates the use of many capacitance measurements in order to determine the minimum, which is the optimal Vcom value. FIG. 8B illustrates a technique what adjusts Vcom iteratively—Vcom voltage may be adjusted until it is sufficiently close to an ideal Vcom value for that point in time. Measurements at two bias voltages are sufficient to determine direction of required Vcom shift, and Vcom can be moved iteratively until measurements balance, indicating correct (optimal) Vcom has been reached. FIG. 8C illustrates an optimization of the two bias voltage measurements of FIG. 8B—rather than just adjusting Vcom in small steps (e.g. in proportion to the difference of measured capacitance), a look-up table (not shown) is used to allow to make larger, more accurate Vcom adjustments, requiring fewer iterations to reach a desired ideal Vcom. The degree of mismatch between the two capacitance measurements is fed into a look-up table and that is used to determine the change in Vcom voltage.

Alternatively to adjusting Vcom directly, the same effect may be achieved by applying a DC shift to all the content instead; for example, the reference voltages may be changed for the content DACs.

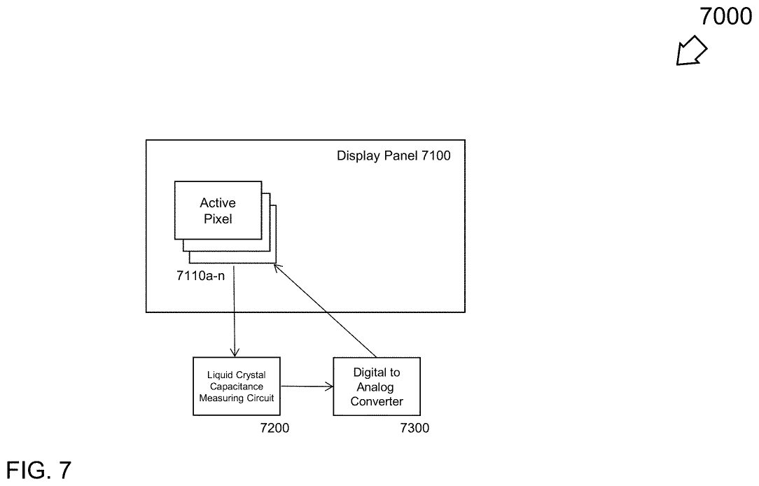

In an alternate embodiment, FIG. 7 is a block diagram of a display device 7000 configured to correct for Vcom shift using active pixels in a LCD panel 7100. In such an embodiment, the display device 7000 comprises a display panel 7100, a liquid crystal capacitance measuring circuit 7200, and a digital to analog converter (DAC) 7300.

Display panel 7100 comprises active pixels 7110a-x, which are visible to users, and are used to display an image visible to a user.

While in operation, display panel 7100 displays images on active pixels 7110a-x. Liquid crystal capacitance measuring circuit 7200 measures the capacitance of active pixels 7120a-n as a substitute for measuring optical transmittance when the active pixels 7120 are not in use, i.e., when a display panel backlight (not shown) is off. It is understood by those familiar with the arts that more complex approaches could be used such as small signal modulation and measurement of active pixels 7120a-n around their content determined DC levels.

The digital to analog converter 7300 receives the capacitance measurement from the liquid crystal capacitance measuring circuit 7200, and adjusts Vcom used by the active pixels 7110a-x for Vcom shift. There are several techniques on how Vcom value may be adjusted or determined. FIG. 8A illustrates the use of many capacitance measurements in order to determine the minimum, which is the optimal Vcom value. FIG. 8B illustrates a technique what adjusts Vcom iteratively—Vcom voltage may be adjusted until it is sufficiently close to an ideal Vcom value for that point in time. Measurements at two bias voltages are sufficient to determine direction of required Vcom shift, and Vcom can be moved iteratively until measurements balance, indicating correct (optimal) Vcom has been reached. FIG. 8C illustrates an optimization of the two bias voltage measurements of FIG. 8B—rather than just adjusting Vcom in small steps (e.g. in proportion to the difference of measured capacitance), a look-up table (not shown) is used to allow to make larger, more accurate Vcom adjustments, requiring fewer iterations to reach a desired ideal Vcom. The degree of mismatch between the two capacitance measurements is fed into a look-up table and that is used to determine the change in Vcom voltage.

Alternatively to adjusting Vcom directly, the same effect may be achieved by applying a DC shift to all the content instead; for example, the reference voltages may be changed for the content DACs.

The adjustment for Vcom drift reduces observable flicker, particularly at low refresh rates. The adjustment further frees up flicker budget, to facilitate power saving features in display panels.

It is understood by those familiar with the art that the system described herein may be implemented in a variety of hardware or firmware solutions.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. An apparatus comprising:
a liquid crystal display panel comprising a plurality of active pixels and a plurality of dummy pixels, the active pixels configured to display an image visible to a user, the dummy pixels being not visible to the user;
a capacitance measuring circuit configured to measure a capacitance of at least one dummy pixel;
a digital to analog converter configured to receive the capacitance of the at least one dummy pixel, and to adjust common voltage (Vcom) received by the active pixels based on the received capacitance of the at least one dummy pixel.

2. The apparatus of claim 1 wherein the Vcom is adjusted until Vcom is close to an ideal Vcom value for a point in time.

3. The apparatus of claim 2 wherein the ideal Vcom is determined with a look-up-table.

4. The apparatus of claim 3 wherein the plurality of dummy pixels is arranged in a column of the liquid crystal display panel.

5. The apparatus of claim 1 wherein the apparatus is a tablet computer, mobile phone, augmented reality display, notebook computer, computer display, or digital watch.

6. A method comprising:
measuring, with a capacitance measuring circuit, a capacitance of at least one dummy pixel of a liquid crystal display panel comprising:
a plurality of active pixels, the active pixels configured to display an image visible to a user, and
a plurality of dummy pixels, the dummy pixels being not visible to the user;
receiving the capacitance of the at least one dummy pixel, with a digital to analog converter; and
adjusting common voltage (Vcom) received by the active pixels based on the received capacitance of the at least one dummy pixel.

7. The method of claim 6 wherein the Vcom is adjusted until Vcom is close to an ideal Vcom value for a point in time.

8. The method of claim 7 wherein the ideal Vcom is determined with a look-up-table.

9. The method of claim 8 wherein the plurality of dummy pixels is arranged in a column of the liquid crystal display panel.

10. The method of claim 6 wherein the liquid crystal display panel is incorporated in a tablet computer, mobile phone, augmented reality display, notebook computer, computer display, or digital watch.

11. An apparatus comprising:
a liquid crystal display panel comprising a plurality of active pixels, the active pixels configured to display an image visible to a user;
a capacitance measuring circuit configured to measure a capacitance of at least one active pixel when the liquid crystal display panel is not in operation;
a digital to analog converter configured to receive the capacitance of the at least one active pixel, and to adjust common voltage (Vcom) received by the active pixels based on the received capacitance of the at least one active pixel.

12. The apparatus of claim 11 wherein the Vcom is adjusted until Vcom is close to an ideal Vcom value for a point in time.

13. The apparatus of claim 12 wherein the ideal Vcom is determined with a look-up-table.

14. The apparatus of claim 13 wherein the liquid crystal display panel is not in operation because a backlight of the liquid crystal display is off.

15. The apparatus of claim 11 wherein the apparatus is a tablet computer, mobile phone, augmented reality display, notebook computer, computer display, or digital watch.

16. A method comprising:
measuring, with a capacitance measuring circuit, a capacitance of at least one active pixel of a liquid crystal display panel when the liquid crystal display panel is not in operation, the active pixels configured to display an image visible to a user;
receiving the capacitance of the at least one active pixel, with a digital to analog converter; and
adjusting common voltage (Vcom) received by the active pixels based on the received capacitance of the at least one active pixel.

17. The method of claim 16 wherein the Vcom is adjusted until Vcom is close to an ideal Vcom value for a point in time.

18. The method of claim 17 wherein the ideal Vcom is determined with a look-up-table.

19. The method of claim 18 wherein the liquid crystal display panel is not in operation because a backlight of the liquid crystal display is off.

20. The method of claim 16 wherein the liquid crystal display panel is incorporated in a tablet computer, mobile phone, augmented reality display, notebook computer, computer display, or digital watch.
